(19) United States
(12) Patent Application Publication
(10) Pub. No.: US 2013/0283267 A1
(43) Pub. Date: Oct. 24, 2013

(54) VIRTUAL MACHINE CONSTRUCTION

(71) Applicants: James C. Cooper, Bloomington, IN (US); Boris Balacheff, Lyon (FR); Keith R. Kuchler, Timnath, CO (US)

(72) Inventors: James C. Cooper, Bloomington, IN (US); Boris Balacheff, Lyon (FR); Keith R. Kuchler, Timnath, CO (US)

(73) Assignee: Hewlett-Packard Development Company LP

(21) Appl. No.: 13/453,285

(22) Filed: Apr. 23, 2012

(51) Int. Cl. G06F 9/455; G06F 15/16

(52) U.S. Cl. 718/1

(57) ABSTRACT

A virtual machine is constructed using a first file received at an endpoint from at least one remote server across a wide area network and a second file received at the endpoint from a local network of the endpoint.

### BACKGROUND

When a virtual machine or virtual appliance is distributed to an endpoint for the first time, such as a personal computer, current method requires the entire virtual machine is distributed. Transmitting the entire virtual machine consumes both time and bandwidth.

### BRIEF DESCRIPTION OF THE DRAWINGS

FIG. 1 is a schematic illustration of an example virtual machine building system.

FIG. 2 is a flow diagram of an example virtual machine construction method that may be performed by the system of FIG. 1.

FIG. 3 is a flow diagram of another example virtual machine construction method that may be performed by the system of FIG. 1.

FIG. 4 is a schematic illustration of an example implementation of the virtual machine building system of FIG. 1.

FIG. 5 is a flow diagram of an example virtual machine construction method that may be performed by the system of FIG. 4.

FIG. 6 is a schematic illustration of another example implementation of the virtual machine building system of FIG. 1.

FIG. 7 is a flow diagram of an example virtual machine construction method that may be performed by the system of FIG. 6.

### DETAILED DESCRIPTION OF THE EXAMPLE IMPLEMENTATIONS

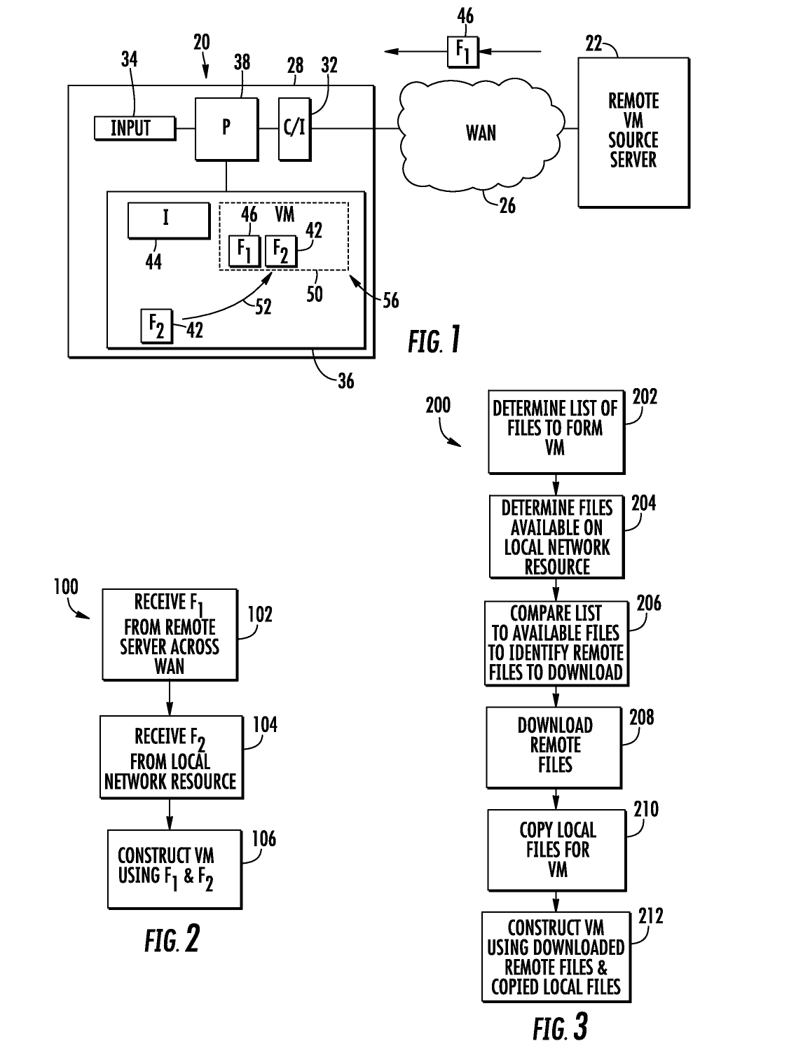

FIG. 1 schematically illustrates an example virtual machine building system 20. As will be described hereafter, system 20 constructs a virtual machine at an endpoint on a local platform utilizing locally available files in combination with remotely available files to reduce time and bandwidth consumption. System 20 comprises remote virtual machine source server 22, wide area network 26 and the local platform 28.

Virtual machine source server 22 comprises one or more servers that store and supply virtual machines to local platforms. For purposes of this disclosure, a “virtual machine” is a software implementation of machine (a computer) that executes programs like a physical machine. The virtual machine (sometimes also referred to as a virtual appliance) may be comprised of multiple files. Examples of such files include, but are not limited to, files having virtual hard drive extensions (.vhd) or virtual machine disk formats (.vmdk) such as utilized in VMWARE products.

Wide area network 26 comprise a telecommunication network that covers a broad area, examples of which include the Internet, cell phone networks and the like (distinguished from personal area networks or local area networks). Wide area network 26 allows for the transmission of virtual machine from server 22 to local platform 28.

Local platform 28 comprises a local computing station or entity connected to wide area network 26 either directly or through a local area network. Examples of local platform 28 may comprise a desktop computer, a laptop computer, a local area network server, a personal data assistant, a smart phone, or any other portable or any other portable or stationary computing device that may store an run a virtual machine. In the example illustrated, local platform 28 comprises communications interface 32, input 34, memory 36 and processor 38.

Communications interface 32 comprises a device by which processor 38 interfaces or communicates to remote systems and devices through wide area network 26. Examples of communications interface 32 include, not limited to, a modem.

Input 34 comprises an interface by which commands, requests or instructions are provided to processor 38. Input 34 may include a user interface such as a mouse, keypad, touch screen, display, keyboard, touchpad, keypad, microphone and speech recognition software the like. Input 34 may also comprise ports by which commands or instructions are transmitted to processor 38.

Memory 36 comprises a non-transient computer-readable medium upon which computer-readable programs or code and data is written or stored. The software forming the virtual machine may be stored in memory 36. In the example illustrated, memory 36 comprises virtual memory file 42 and instructions 44. Virtual machine file 42 comprises a file residing on memory 36 of local platform 28 that may be used to construct or form a virtual machine. As noted above, examples such virtual machine files include files in a virtual hard drive or virtual machine disk format. In one scenario, file 42 may exist as part of a virtual machine residing on memory 36. In another implementation, file 42 may exist in memory 36 outside of or independent of a virtual machine. File 42 may have been previously received across wide area network 26 and stored in memory 36 (individually or as part of a virtual machine), may have been copied directly from another platform or resource across a local area network or may have been locally installed on memory 36 such as with a local flash drive or disk reader (individually or as part of a virtual machine).

Instructions 44 comprises computer-readable code or computer-readable programming which direct the operation of processing unit 38. Processor 38 comprises one or more processing units configured to construct a virtual machine and to manage such constructed virtual machines in accordance with instructions 44 stored on memory 36. For purposes of this application, the term “processing unit” shall mean a presently developed or future developed processing unit that executes sequences of instructions (such as instructions 44) contained in a memory, such as memory 36. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processor 38 may be embodied as part of one or more application-specific integrated circuits (ASICs). Unless otherwise specifically noted, the processor 38 is not limited to any specific combination of hardware circuitry and software, nor to any particular source for the instructions executed by the processing unit.

In one implementation, instructions 44 may comprise a virtual machine builder and a hypervisor. The virtual machine builder comprises one or more modules that construct a virtual machine using virtual machine files. The hypervisor manages the running of one or more virtual machines on the local platform 28. In other implementations, instructions 44 may have other forms.

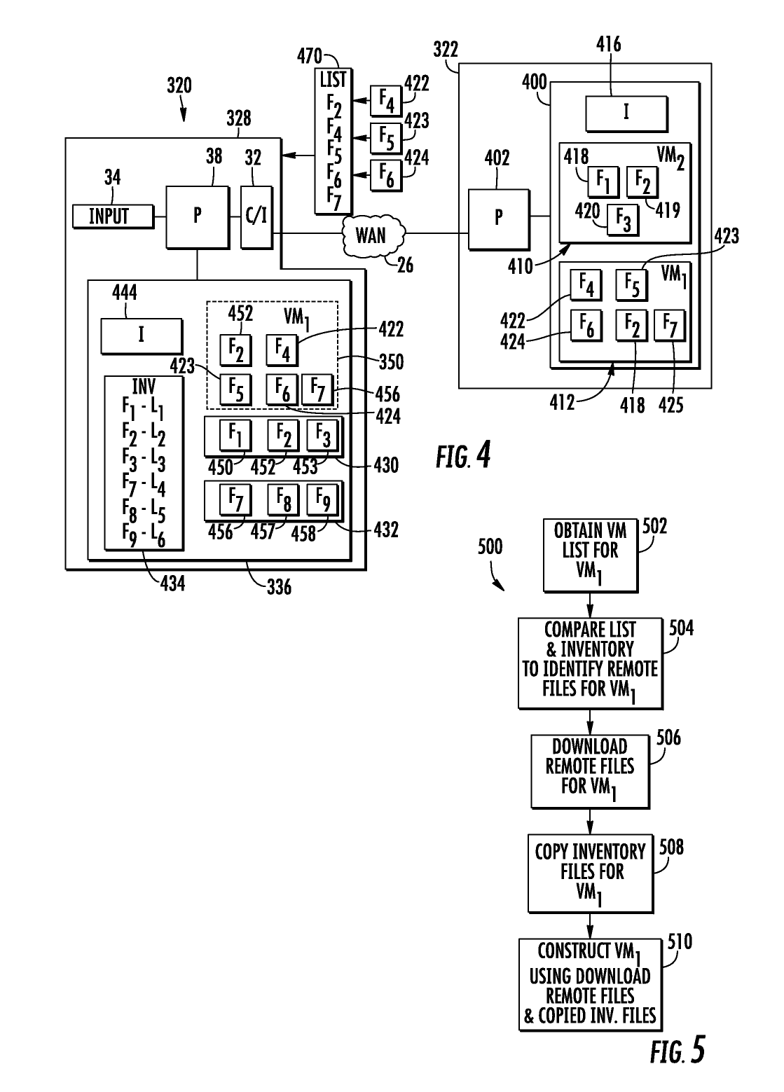

Instructions 44 direct a processor 38 to carry out the example method 100 shown in the flow diagram of FIG. 2. In response to receiving a request through input 34 for forming a virtual machine 50 (shown in broken lines) and as indicated in step 102, processor 38 on local platform 28 receives virtual machine file 46 from remote virtual machine source server 22 across wide area network 26. Virtual machine file 46 comprises a file that is used to form part of the virtual machine 50 (shown in broken lines) that is to be constructed on memory 36. As noted above, an example of such a virtual machine 46 is a file in a virtual hard drive or virtual machine disk format.

As indicated by step 104 and depicted by arrow 52 in FIG. 1, processor 38 is further instructed by instructions 44 to receive or obtain virtual machine file 42 from a local network or local network resource. Virtual machine file 42 is a file that is used in conjunction with other files to form the virtual machine 50 that is to be constructed at an endpoint on memory 36. For purposes of this disclosure, a local network or local network resource means a device or memory associated with the device within the local area network which includes local platform 28. A local network resource comprises either a device or memory that is connected to or in communication with local platform 28 directly across a local area network (without use of wide area network 26) or the memory 36 on the local platform 28 itself.

As indicated by step 106, instructions 44 direct a processor 38 to construct the virtual machine 50 an endpoint 56 using virtual machine files 46 and 42. Although not illustrated, virtual machine 50 may be formed from additional virtual machine files as well. Some of such files may be obtained from one or more servers 22 across wide area network 26 while other of such files may be obtained from memory 36 on local platform 28 or from other memories within the local area network in which local platform 28 resides. Because system 20 forms the virtual machine 50 utilizing virtual machine files that reside in the local area network resources (platforms directly connected by a local area network) and possibly even on memory 36 of the local platform 28 itself, not all the files utilized to form virtual machine 50 have to be downloaded across wide area network 26. As a result, the formation or construction of virtual machine 50 consumes less bandwidth across wide area network 26 and may be completed in less time.

FIG. 3 is a flow diagram of an example method 200 that may be carried out by system 20 in FIG. 1. In response to receiving a request or instruction through input 34 to form virtual machine 50 and as indicated by step 202, processor 38 determines a list of files that form virtual machine 50. In one implementation, processor 38 transmits the identity of virtual machine 50 to server 22, wherein server 22 determines a list or manifest of virtual machine files that form virtual machine 50 and returns the list or manifest back to processor 38 across wide area network 26. In one implementation, processor 38 may itself consult information contained in memory 36 to identify what virtual machine files form virtual machine 50 or may consult an alternative source for the list over wide area network 26 or over a local area network.

As indicated by step 204, processor 38, following instructions 44, determines what virtual machine files are available on the local network or among the local network resources. As noted above, such files may be located on the local platform 28 itself (in memory 36) or may reside on a memory of another device within the local area network of platform 28. In one implementation, processor 38 may, following instructions 44, perform a scan of existing files residing in memory 36 or on the local area network. In another implementation, processor 38 may maintain or periodically update an inventory of virtual machine files that reside in memory 36 or on the local area network, wherein the inventory is stored in memory 36 or on another memory within the local area network resources which include platform 28. In yet other implementations, one or more remote servers, such as server 22 or another server, may store or maintain in inventory of virtual machine files (files that are used to construct the virtual machine) that either reside in memory 36, that reside in the local area network of platform 28, that have been downloaded to devices on the local area network, or that have been downloaded to local platform 28.

As indicated by step 206, system 20 compares the list of virtual machine files that form virtual machine 50 to the inventory of locally available files to identify those files that should be downloaded from server 22 across wide area network 26. In one implementation, processor 38 may carry out this comparison and make this determination. In another implementation, server 22 may carry out this comparison and make this determination.

As indicated by step 208, system 20 downloads the remote files residing on server 22 that are used to form virtual machine 50. In one implementation, server 22 pushes such identified files to processor 38. In other implementations, processor 38 pulls such identified virtual machine files from server 22.

As indicated by step 210, system 20 further copies those virtual machine files used to form virtual machine 50 that already or currently reside locally, on memory 36 or within the local area network of platform 28. As indicated by step 212, processor 38, following instructions 44, constructs virtual machine 50 utilizing the downloaded remote files, such as file 46) and the copied local files, such as file 42.

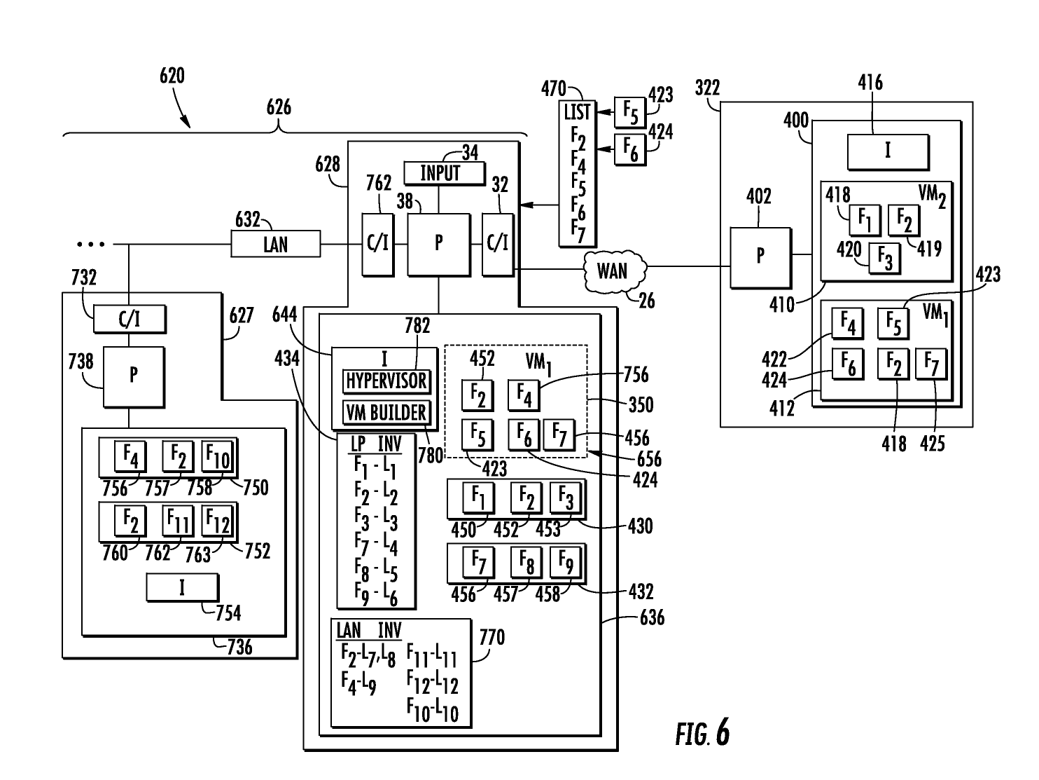

FIG. 4 schematically illustrates virtual machine building system 320, an example implementation of system 20. System 320 comprises remote virtual machine source server 322, wide area network 26 (described above) and the local platform 328. Virtual machine source server 322 is similar to server 22. Server 322 comprises memory 400 and processor 402. Memory 400 comprises one or more non-transient computer- readable mediums upon which programs code or instructions are stored as well upon which data is stored. In the example illustrated, memory 400 stores multiple virtual machines 410, 412 and instructions 416. Virtual machine 410 comprises a virtual machine formed from virtual machine files 418, 419 and 420. Virtual machine 412 comprises a different virtual machine formed from virtual machine files 418, 422, 423, 424 and 425. Such virtual machines 410 and 412 are configured for distribution across wide area network 26 by processor 402.

Instructions 416 comprises computer readable programming or code configured to direct processor 402 to carry out functions and operations of server 22, such as responding to external requests for the transmission of virtual machines 410, 412. As will be described hereafter, instructions for 16 further direct processor 402 to cooperate with local platform 328 in the construction of virtual machine 350 using one or more virtual machine files provided by server 322.

Local platform 328 is similar to local platform 28. Local platform 328 comprises a local computing station or entity connected to wide area network 26 either directly or through a local area network. Examples of local platform 328 may comprise a desktop computer, a laptop computer, a local area network server, a personal data assistant, a smart phone, or any other portable or any other portable or stationary computing device that may store and run a virtual machine. In the example illustrated, local platform 328 comprises communications interface 32, input 34, memory 336 and processor 38. Interface 32, input 34 and processor 38 are each described above with respect to FIG. 1.

Memory 336 comprises a non-transient computer-readable medium upon which computer-readable programs or code and data are stored. The software forming the virtual machine 350 to be formed may be stored in memory 336. In the example illustrated, memory 336 comprises virtual machines 430, 432, inventory 434 and instructions 444. Virtual machines 430, 432 comprise different virtual machines residing in memory 336 that have been previously installed, previously constructed or previously downloaded. Virtual machine 430 is formed from or includes virtual machine files 450, 452 and 453 which are each different from one another. Virtual machine 432 is formed from or includes virtual machine files 456, 457 and 458, which are different from one another. In the present disclosure, actual files are identified with reference numerals while the content of such files is identified with designations Fₓ, where two different files may be identical to one another in that they contain the exact same content Fₓ. For example, virtual machine files 418 and 452 shown in FIG. 4 are different files, each of which contain the exact same virtual machine file content F₂.

Inventory 434 comprises an inventory or list of virtual machine files that presently reside in memory 336. In the example illustrated, inventory 434 further identifies or tracks a location or locations in memory 336 for each of the virtual machine files. In one implementation, processor 38 generates and maintains inventory 434. Each time a new virtual machine or a virtual machine file (a file that forms part of a virtual machine) is downloaded or installed, processor 38 adds an identifier and an address for the new locally residing virtual machine file content to inventory 434. In some implementations, processor 38 may additionally update inventory 434 by removing the identifier and the address for a virtual machine file that is removed from memory 336 such that it is no longer residing on memory 336.

In another implementation, devices other than local platform 328 may be charged with maintaining or updating inventory 434. For example, in other implementations, a processor of another device in the local area network containing local platform 328 may maintain or update inventory 434. In other implementations, processor 402 of server 322 may update inventory 434 on memory 336 each time server 322 downloads a virtual machine or an individual virtual machine file to local platform 328. In other implementations, inventory 434 may alternatively be stored in other memory locations. For example, instead of residing in memory 336, inventory 434 may be stored and reside on a memory of another device within the local area network of local platform 328. In another implementation, instead of residing in memory 336, inventory 434 may be stored and reside on a memory of another device remote from the local area network of platform 328 and remote from platform 328 across wide area network 26. For example, inventory 434 may alternatively be stored in memory 400.

Instructions 444 comprises computer-readable code or computer-readable programming which direct the operation of processor 38. Following such instructions 444, processor 38 constructs a new virtual machine 350. In one implementation, instructions 444 direct processor 38 to carry out the example method 500 illustrated in the flow diagram of FIG. 5.

In response to a request for forming virtual machine 350, such as a request through input 34, processor 38 initiate the construction of virtual machine 350. As indicated by step 502 in FIG. 5, processor 38, following instructions 444, obtains virtual machine list 470. In the example illustrated, processor 38 identifies virtual machine 350 to server 322 across wide area network 26. Processor 402 of server 322 receives a request and generates list 470. After generating list 470, processor 402 transmits list 470 across wide area network 26 to processor 38. As shown by FIG. 4, list 470 provides a listing of identifiers for those virtual machine files which form virtual machine 350. The listing does not include the virtual machine files themselves.

In other implementations, processor 38 may obtain the list of virtual machine files for virtual machine 350 from other sources. For example, processor 38 may obtain the list from a database of information stored in memory 336, from a database of information stored in a memory of another device on a local area network resource including local platform 328 or from a database of information from a memory of a remote device across wide area network 26.

As indicated by step 504, processor 38, following instructions 444, compares list 470 which inventory 434 to identify remote files for virtual machine 350 that should be downloaded from server 322. In other implementations, this comparison may alternatively be carried out by processor 402 of server 322, especially in those implementations where inventory 434 is stored in memory 400 of server 322. In the example illustrated, such a comparison reveals that virtual machine files 452 (containing file content F₂) and 458 (containing file content F₇) identified in list 470 presently reside in memory 336. In particular, virtual machine file 452 reside as part of virtual machine 430 while virtual machine 458 reside as part of virtual machine 432. As a result, the comparison reveals that virtual machine files 422, 423 and 424 should be downloaded from server 322 to facilitate the construction of virtual machine 350.

As indicated by step 506 and FIG. 5, instructions 444 direct processor 38 to download those remote files (files number 422, 423 and 424) identified from the comparison from server 322 across wide area network 26. As indicated by step 508, instructions 444 further instruct processor 38 to copy those virtual machine files for virtual machine 3 350 that presently reside on memory 336 (inventory files). As indicated by step 212, processor 38, following instructions 444, constructs virtual machine 350 utilizing the downloaded remote files 422, 423, 424 and the copied local files 452, 458. Because system 320 forms the virtual machine 350 utilizing virtual machine files that reside on memory 336 of the local platform 328 itself, not all the files utilized to form virtual machine 350 have to be downloaded across wide area network 26. As a result, the formation or construction of virtual machine 350 consumes less bandwidth across wide area network 26 and may be completed in less time.

FIG. 6 schematically illustrates virtual machine building system 620, a particular example implementation of virtual machine building system 20. System 620 is similar to systems 20 and 320 in that system 620 constructs a virtual machine at an endpoint on a local platform utilizing locally available files in combination with remotely available files to reduce time and bandwidth consumption. System 620 comprises remote virtual machine source server 322, wide area network 26 and local area network resources 625, comprising local platforms 627, 628 interconnected by local area network 632. Virtual machine source server 322 and wide area network 26 are described above with respect to system 320.

Platform 627 comprises a local computing station or entity connected to local platform 628 either directly or through a local area network 632. Examples of platform 627 may comprise a desktop computer, a laptop computer, a local area network server, a personal data assistant, a smart phone, or any other portable or any other portable or stationary computing device having a memory that may store a virtual machine or files that may be utilized in forming a virtual machine on another platform. In the example illustrated, platform 627 comprises communications interface 732, memory 736 and processor 738. Communication interface 732 comprises a network communication device, such as a modem or router, that facilitates communication between platform 627 and other devices or platforms, such as platform 628, across local area network 632.

Memory 736 comprises a non-transient computer-readable medium configured to store instructions for processor 738 and data, such as files, applications and virtual machines. In the example illustrated, memory 736 comprises virtual machines 750, 752 and instructions 754. Virtual machine 750 comprises virtual machine files 756, 757 and 758. Virtual machine 752 comprises virtual machine files 760, 762 and 763. Instructions 754 comprises programming or code for the operational processor 738. Such instructions 754 may include applications such as a hypervisor for managing the operation of virtual machines 750, 752. Such instructions may include a virtual machine builder for building additional virtual machines on platform 627.

Local platform 628 is similar to local platform 328. In the example in which platform 628 is illustrated as communicating with platform 627 across local area network 632, local platform 628 additionally includes a communication interface 762 to facilitate communication across local area network 632. Communication interface 762 may comprise such network medication devices as a modem or router.

As with platform 328, platform 628 includes communication interface 32, input 34 and processor 38 (described above). Platform 628 additionally includes memory 636. Memory 636 comprises a non-transient computer-readable medium upon which computer-readable programs or code and data are stored. The software forming the virtual machine 350 to be formed will be stored in memory 336. In the example illustrated, memory 336 comprises virtual machines 430, 432, local platform inventory 434, local area network inventory 770 and instructions 644. Virtual machines 430, 432 are described above and comprise different virtual machines residing in memory 636 that have been previously installed, previously constructed or previously downloaded.

Local platform inventory 434 comprises an inventory or list of virtual machine files that presently reside in memory 636. In the example illustrated, inventory 434 further identifies or tracks a location or locations in memory 636 for each of the virtual machine files (identified with the same file content designations Fₓ). In one implementation, processor 38 generates and maintains inventory 434. Each time a new virtual machine or a virtual machine file (a file that forms part of a virtual machine) is downloaded or installed, processor 38 adds an identifier and an address for the new locally residing virtual machine file to inventory 434. In some implementations, processor 38 may additionally update inventory 434 by removing the identifier and the address for a virtual machine file that is removed from memory 636 such that it is no longer residing on memory 636.

In another implementation, devices other than local platform 628 may be charged with maintaining or updating inventory 434. For example, in other implementations, the processor of another device in the local area network containing local platform 628, such as processor 738, may maintain or update inventory 434. In other implementations, processor 402 of server 322 may update inventory 434 on memory 636 each time server 322 downloads a virtual machine or an individual virtual machine file to local platform 628. In other implementations, inventory 434 may alternatively be stored in other memory locations. For example, instead of residing in memory 636, inventory 434 may be stored and reside on a memory of another device within the local area network of local platform 328. In another implementation, instead of residing in memory 636, inventory 434 may be stored and reside on a memory of another device remote from the local area network of platform 628 and remote from platform 628 across wide area network 26. For example, inventory 434 may alternatively be stored in memory 400.

Local area network (LAN) inventory 770 comprises an inventory or list of virtual machine files that presently reside in the memory of other devices or platforms directly connected to local platform 628 by local area network 632. In the particular example illustrated, inventory 770 comprises an inventory or list of virtual machine files contained in platform 627. In the example illustrated, inventory 770 further identifies or tracks a location or locations for each of the virtual machine files. In one implementation, processor 38 generates and maintains inventory 770. Each time a new virtual machine or a virtual machine file (a file that forms part of a virtual machine) is downloaded or installed on any local area network resource (any device directly connected to one another by local area network 632), processor 38 adds an identifier and an address for the new locally residing virtual machine file to inventory 770. In some implementations, processor 38 may additionally update inventory 770 by removing the identifier and the address for a virtual machine file that is removed from a local area network resource such that it is no longer residing on one of the local area network resources.

In another implementation, devices other than local platform 628 may be charged with maintaining or updating inventory 770. For example, in other implementations, the processor of another device in the local area network containing local platform 628, such as processor 738, may maintain or update inventory 770. In other implementations, processor 402 of server 322 may update inventory 770 on memory 636 each time server 322 downloads a virtual machine or an individual virtual machine file to any of the local area network resources other than local platform 628. In other implementations, inventory 770 may alternatively be stored in other memory locations. For example, instead of residing in memory 636, inventory 770 may be stored and reside on a memory of another local area network resource. In another implementation, instead of residing in memory 636, inventory 770 may be stored and reside on a memory of another device remote from the local area network of platform 628 and remote from platform 628 across wide area network 26. For example, inventory 434 may alternatively be stored in memory 400. Although illustrated as comprising two distinct areas of memory 636, in some implementations, the inventories 434 and 770 may be combined as a single inventory list.

Instructions 644 comprises computer-readable code or computer-readable programming which direct the operation of processor 38. In the example illustrated, instruction 644 includes code or programming forming virtual machine builder 780 and hypervisor 782. Virtual machine builder 780 comprises a software or programming module that in the construction of a virtual machine. Hypervisor 782 comprises a software or programming module that directs processor 38 in the management and running of one or more virtual machines that have been constructed on the local platform 628.

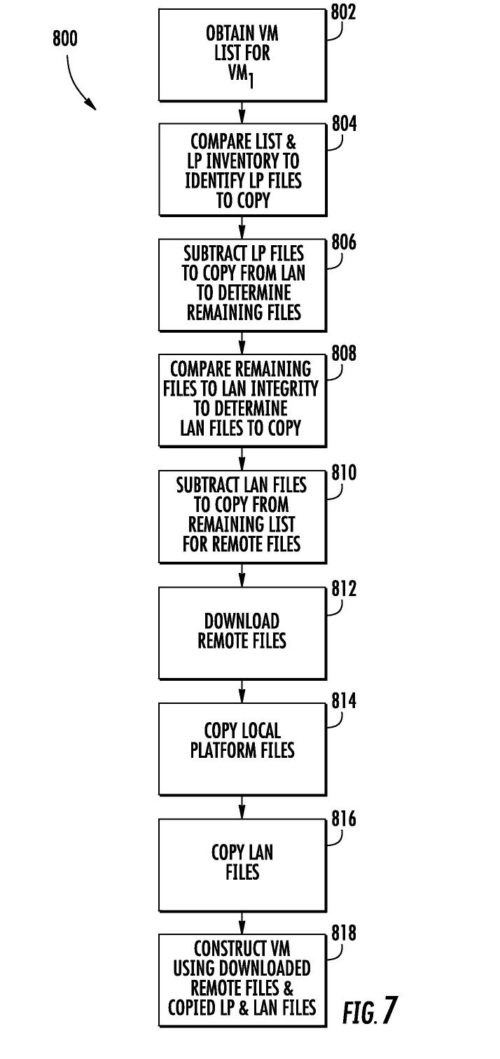

Following instructions provided by virtual machine builder 780, processor 38 constructs a new virtual machine 350. In one implementation, virtual machine builder 780 directs processor 38 to carry out the example method 800 illustrated in a flow diagram of FIG. 7.

In response to a request for forming virtual machine 350, such as a request through input 34, processor 38 initiate the construction of virtual machine 350. As indicated by step 802 in FIG. 7, processor 38, following instructions from virtual machine builder 780, obtains virtual machine list 470. In the example illustrated, processor 38 identifies virtual machine 350 to server 322 across wide area network 26. Processor 402 of server 322 receives the request and generates list 470. After generating list 470, processor 402 transmits list 470 across wide area network 26 to processor 38. As shown by FIG. 6, list 470 provides a listing of identifiers for those virtual machine files which form virtual machine 350. The listing does not include the virtual machine files themselves.

In other implementations, processor 38 may obtain the list of virtual machine files for virtual machine 350 from other sources. For example, processor 38 may obtain the list from a database of information stored in memory 636, from a database of information stored in a memory of another device on a local area network resources including local platform 328 or from a database of information from a memory of a remote device across wide area network 26.

As indicated by step 804, processor 38, following instructions 444, compares list 470 with inventory 434 to identify those virtual machine files for the virtual machine 350 that are available on the local platform 628 of the endpoint 656 (the memory 636 on which virtual machine 350 is to be constructed). In other implementations, this comparison may alternatively be carried out by processor 402 of server 322, especially in those implementations where inventory 434 is stored in memory 400 of server 322. In the example illustrated, such a comparison reveals that virtual machine files 452 (file content F₂) and 458 (file content F₇) identified in list 470 presently reside in memory 336. In particular, virtual machine file 452 resides as part of virtual machine 430 while virtual machine 458 resides as part of virtual machine 432.

As indicated by step 806, virtual machine builder 780 substracts the references or identifiers for the identified virtual machine file content available on the local platform 628 for the virtual machine 350 to be constructed from the list 470 of virtual machine file content for constructing virtual machine 350 to determine a second list of remaining file content that should be acquired for constructing the virtual machine 350. In the example illustrated, virtual machine builder 780 directs processor 38 to subtract virtual machine file content F₂ and F₇ from list 470 to arrive at a secondary reduced list of remaining files, virtual machine file content F₄, F₅ and F₆, that should be acquired to form virtual machine 350.

As indicated by step 808, virtual machine builder 780 compares this remaining list of virtual machine files or virtual machine file content to local area network inventory 770 to determine which local area network virtual machine files should be obtained or copied to provide the content for forming virtual machine 350. In the example illustrated, such a comparison would indicate that virtual machine file content F₄ in the remaining list (file content F₄, F₅ and F₆) is available on platform 627.

As indicated by step 810, virtual machine builder 780 substracts the references for the identified virtual machine files available on any of the other platforms of local area network resources 626 (platform 627 in the example) for the virtual machine 350 to be constructed from the list of remaining files determined in step 806 to identify what virtual machine files should still be downloaded from server 322. In another implementation, virtual machine builder 780 may determine what virtual machines should still be downloaded from server 322 by subtracting both the virtual machine files available on the local platform 628 and the virtual machine files available on the other platforms of local area network 626 (platform 627 in the example) from the original manifest or list 470. In the example illustrated, subtracting virtual machine file content F₂ from the remaining list of virtual machine file content (F₂, F₅ and F₆) indicates that virtual machine file content F₅ and F₆ to be downloaded from server 322.

As shown in the example in FIG. 6, the comparison and subtraction steps carried out in sequence pursuant to method 800 result in a prioritization for obtaining virtual machine files from different sources based on acquisition time and acquisition bandwidth consumption. In particular, virtual machine files identified in list 470 are first, to the extent possible, satisfied using virtual machine files available on the local platform 628. In the example illustrated, virtual machine file content F₂ is located on both local platform 628 (file 452 in virtual machine 430) and platform 627 (file 750 in virtual machine 752). However, because virtual machine builder 780 compares list 472 inventory 434 first and then subtracts those local platform files to copy from list 470 prior to consulting inventory 770, virtual machine builder 780 identified and utilizes virtual machine file 452 on local platform 628 for virtual machine file content F₂ instead of virtual machine file 7521 platform 627 for the same content F₂. By acquiring the virtual machine content F₂ from local platform 628 rather than acquiring it from another local area network resource 626 across local area network 632 is smaller. Thus, acquisition time and acquisition bandwidth consumption even amongst local area network resources 626, virtual machine files for constructing virtual machine 350 are obtained in the most efficient manner. In other implementations, such a prioritization may be omitted.

As indicated by step 812 in FIG. 7, virtual machine builder 780 directs processor 38 to download those remote files (files 423 with content F5 and 424 with content F6) identified in step 810 from server 322 across wide area network 26. As indicated by step 814, virtual machine builder 780 further instructs processor 38 to copy those virtual machine files for virtual machine 3 350 that presently reside on memory 636. As indicated by step 816, virtual machine builder 780 further instructs processor 38 to copy those virtual machine files for virtual machine 350 that presently reside on the other platforms of local area network resource 626 (platform 627 in the example). As indicated by step 818, virtual machine builder 780 directs processor 38 to construct virtual machine 350 utilizing the downloaded remote files 423, 424, the copied local platform virtual machine files 452, 458 and the obtained or copied local area network virtual machine file 756. Because system 320 forms the virtual machine 350 utilizing virtual machine files that reside on memory 336 of the local platform 628 itself for that reside as part of local area network resources 626, not all the files utilized to form virtual machine 350 have to be downloaded across wide area network 26. As a result, the formation or construction of virtual machine 350 consumes less bandwidth across wide area network 26 and may be completed in less time.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
receiving at an endpoint a first file for a virtual machine from at least one remote server across a wide area network;
receiving at the endpoint a second file for the virtual machine from a local network of the endpoint; and
constructing the virtual machine using the first file and the second file.

2. The method of claim 1 further comprising:
determining a list of files to form the virtual machine;
determining files available on the local network; and
comparing the list of files to form the virtual machine to the files available on the local network.

3. The method of claim 2, wherein the comparing is carried out at the endpoint.

4. The method of claim 2, wherein the comparing is carried out at the least one remote server.

5. The method of claim 2 further comprising storing an inventory of all virtual machine files received by the local network.

6. The method of claim 5, wherein the inventory is stored at the local network.

7. The method of claim 1, wherein prior to transmitting the virtual machine across the wide area network from the least one remote server, transmitting a list of files forming the virtual machine to be transmitted from the at least one server to the endpoint.

8. The method of claim 1 further comprising receiving the second file for the virtual machine from a first virtual machine on the local network.

9. The method of claim 8 further comprising receiving a third file for the virtual machine from a second virtual machine on the local network, wherein the virtual machine is constructed from the first file, the second file and the third file.

10. An apparatus comprising:
a non-transient computer-readable medium comprising computer readable code to direct a processor at an endpoint to:
receive at the endpoint a first file for a virtual machine from at least one remote server across a wide area network;
receive at the endpoint a second file for the virtual machine from a local platform containing the endpoint; and
constructing the virtual machine using the first file and the second file.

11. The apparatus of claim 10, wherein the computer readable code further directs the processor to:
determining a list of files to form the virtual machine;
determining files available on the local network; and
comparing the list of files to form the virtual machine to the files available on the local network.

12. The apparatus of claim 10, wherein the computer readable code further directs the processor to store an inventory of all virtual machine files received by the local network.

13. The apparatus of claim 10, wherein the computer readable code further directs the processor to receive a third file for the virtual machine from a second virtual machine on the local network, wherein the virtual machine is constructed from the first file, the second file and the third file.

14. An apparatus comprising:
a hypervisor on a local platform;
a virtual machine builder on the local platform, the virtual machine builder to:
determine a list of files to form a virtual machine;
determining local files available on the local platform for forming the virtual machine;
compare the list of files to form the virtual machine to the local files available on the local platform for forming the virtual machine to identify remote files to be downloaded from a remote server across a wide area network;
downloading the remote files across the wide area network;
copying the local files available on the local platform for forming the virtual machine; and
construct the virtual machine using the downloaded remote files and the copied local files.

15. The apparatus of claim 14, wherein the virtual machine builder maintains an inventory of downloaded virtual machine files.
